(19) United States
(12) Patent Application Publication
(10) Pub. No.: US 2025/0016080 A1
(43) Pub. Date: Jan. 9, 2025

(54) FRAME DETERMINATION DEVICE, FRAME DETERMINATION METHOD, STORAGE MEDIUM STORING FRAME DETERMINATION PROGRAM, AND FRAME DETERMINATION SYSTEM

(71) Applicant: DENSO CORPORATION, Kariya-city (JP)

(72) Inventors: Remma TAKEUCHI, Kariya-city (JP); Tatsuro KAWAKAMI, Kariya-city (JP)

(21) Appl. No.: 18/762,711

(22) Filed: Jul. 3, 2024

(30) Foreign Application Priority Data
Jul. 5, 2023 (JP) 2023-110928

(51) Int. Cl. H04L 43/0852; H04L 43/10; H04L 67/12

(52) U.S. Cl. CPC H04L 43/0852; H04L 43/10; H04L 67/12

(57) ABSTRACT

A frame determination device connected to a network that transmits a cycle frame and an event frame transmitted from an electronic control device is configured to receive a first data frame; calculate a reception interval between the first data frame and a second data frame; determine whether the first data frame is the cycle frame based on the reception interval; calculate a difference between a reception time of an N-th actual received frame and a predicted reception time of an N-th virtual received frame; determine whether the first data frame is an event frame or an abnormal frame different from the event frame; and an output unit that is configured to output a determination result of the first data frame.

### CROSS REFERENCE TO RELATED APPLICATION

This application is based on Japanese Patent Application No. 2023-110928 filed on Jul. 5, 2023, the disclosure of which is incorporated herein by reference.

### TECHNICAL FIELD

The present disclosure relates to a device for determining a data frame transmitted from an electronic control device, a method and program executed by the device, and a system including the device.

### BACKGROUND

Conventionally, various types of electronic control units are mounted on an automobile, and an in-vehicle system includes these electronic control units connected to each other via a communication network. Such in-vehicle system is known to use a Network-based Intrusion Detection System (NIDS) to detect whether there is a suspicious access or data from the outside.

A related art discloses a communication system capable of determining whether messages communicated in the communication system are normal or abnormal with a simple configuration. In this communication system, multiple ECUs are connected to a communication bus to enable communication of messages. A specified communication interval is set for each ECU. The ECU transmitting the message transmits the message based on the specified communication interval. When the communication interval of the received messages is shorter than the specified communication interval, it is determined that the messages are not normal.

Another related art discloses a relay connection unit that relays a message transmitted and received between electronic control units. In the relay connection unit, the number of times of reception of messages within a preset time is counted. When the number of times of reception exceeds a preset set number of times, it is determined that the messages are not normal.

### SUMMARY

A frame determination device connected to a network that transmits a cycle frame and an event frame transmitted from an electronic control device is configured to receive a first data frame; calculate a reception interval between the first data frame and a second data frame; determine whether the first data frame is the cycle frame based on the reception interval; calculate a difference between a reception time of an N-th actual received frame and a predicted reception time of an N-th virtual received frame; determine whether the first data frame is an event frame or an abnormal frame different from the event frame; and an output unit that is configured to output a determination result of the first data frame.

### BRIEF DESCRIPTION OF Tt1E DRAWINGS

Objects, features and advantages of the present disclosure will become more apparent from the following detailed description made with reference to the accompanying drawings. In the drawings:

FIG. 1 is a diagram illustrating an in-vehicle system including a log determination device according to the first embodiment or the second embodiment;

FIG. 2A to FIG. 2C are diagrams explaining frames transmitted and received in the first embodiment or the second embodiment;

FIG. 3 is a diagram illustrating a configuration example of the log determination device according to the first embodiment or the second embodiment;

FIG. 4 is a diagram illustrating the first difference calculated by the log determination device of the first embodiment;

FIG. 5 is a diagram illustrating the second difference calculated by the log determination device of the first embodiment;

FIG. 6 is a diagram illustrating the first difference calculated by the log determination device of the first embodiment;

FIG. 7 is a diagram illustrating the second difference calculated by the log determination device of the first embodiment;

FIG. 8 is a diagram explaining the operation of the frame determination device of the first embodiment;

FIG. 9 is a diagram illustrating the first difference calculated by the log determination device of the second embodiment;

FIG. 10 is a diagram illustrating the first difference calculated by the log determination device of the second embodiment; and

FIG. 11 is a diagram explaining the operation of the frame determination device according to the second embodiment.

### DETAILED DESCRIPTION

All of the methods described in prior art literatures determine abnormal messages on a premise that messages are transmitted and received at a specified communication interval. However, messages sent and received between ECUs may include messages sent and received when some event occurs, in addition to messages sent and received at regular communication intervals. Since such messages are usually not sent and received at regular communication intervals, it is not possible to determine whether or not the messages are normal using conventional techniques.

The present disclosure provides a technique to determine, when a message is received at an interval other than a predetermined communication interval, whether the message is to be sent and received when an event occurs, or whether it is an invalid message.

According to one aspect of the present disclosure, a frame determination device connected to a network that transmits a cycle frame and an event frame transmitted from an electronic control device is provided. The cycle frame is a data frame that is transmitted at a predetermined cycle starting from transmission of the cycle frame or the event frame that have been transmitted immediately before from the electronic control device. The event frame is a data frame that is transmitted when a predetermined event occurs regardless of the predetermined cycle. The frame determination device includes: reception unit that is configured to receive a first data frame; a reception interval calculation unit that is configured to calculate a reception interval between the first data frame and a second data frame, which is the cycle frame or the event frame received by the reception unit immediately before the first data frame; a first determination unit that determines whether the first data frame is the cycle frame based on the reception interval; a difference calculation unit that is configured to calculate a difference between a reception time of an N-th (N being an integer greater than or equal to 1) actual received frame, which is a data frame actually received by the reception unit after the first data frame, and a predicted reception time of an N-th virtual received frame, which is a cycle frame that the reception unit predicts to receive after the first data frame when the first data frame is assumed to be an event frame, when the first determination unit determines that the first data frame is not the cycle frame; a second determination unit that is configured to determine, based on the difference, whether the first data frame is an event frame or an abnormal frame different from the event frame; and an output unit that is configured to output a determination result of the first data frame.

With the above configuration, when a received data frame is not a data frame transmitted at a predetermined cycle, it is possible to determine whether the received data frame is an event frame transmitted due to the occurrence of an event or an abnormal frame. can be determined.

Hereinafter, embodiments of the present disclosure will be described with reference to the drawings.

Any effects described in embodiments may be effects obtained by a configuration of an embodiment as an example of the present disclosure, and may not be necessarily effects of the present disclosure.

In the present disclosure, the configuration disclosed in each embodiment is not limited to each embodiment alone, but may be combined across the embodiments. For example, a configuration disclosed in one embodiment may be combined with another embodiment. The disclosed configurations in respective multiple embodiments may be partially combined with one another.

### 1. Configurations Common to Embodiments

### (1) In-Vehicle System 1

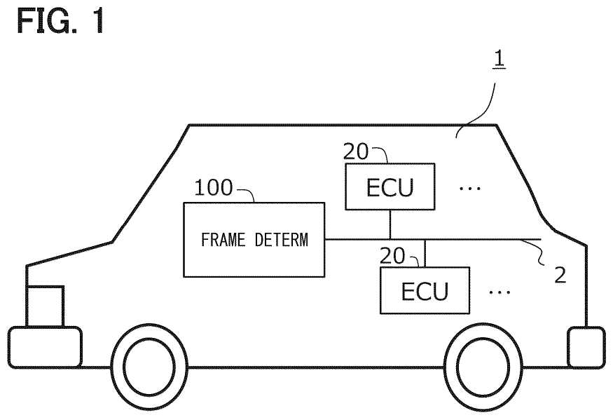

FIG. 1 shows an in-vehicle system 1 including a frame determination device 100, a plurality of electronic control devices 20, and a communication network 2 connecting these devices to each other. The in-vehicle system 1 corresponds to a “frame determination system. An electronic control device 20 corresponds to an electronic control unit (ECU). In each of the embodiments, an electronic control device configured as a gateway has a function as a frame determination device 100, and is configured to receive a data frame transmitted from the ECU 20 and perform a series of frame determination processes described below. The frame determination device 100 of the present embodiment is not limited to an electronic control device of a gateway. For example, the frame determination device 100 of the present embodiment may be provided in the in-vehicle system 1 as an electronic control device exclusively for frame determination, or each ECU 20 configuring the in-vehicle system 1 may function as the frame determination device 100.

The communication network 2 is a network that transmits a cycle frame and an event frame, which will be described later. The communication network 2 can use any communication method, such as Ethernet (registered trademark), Wi-Fi (registered trademark), Bluetooth (registered trademark), or the like, in addition to communication methods such as CAN (Controller Area Network) and LIN (Local Interconnect Network), for example. In the following example, an example using CAN will be described.

Each embodiment is described with an example in which the frame determination device 100 and the ECU 20 are devices comprising the in-vehicle system 1 mounted on in a vehicle. However, the frame determination device 100 is not limited to a device mounted on a vehicle, and can be applied to any system.

### (2) ECU 20

The ECU 20 is an “electronic control unit” that periodically transmits data frames to the frame determination device 100, that is, at a predetermined cycle. Each of data frames transmitted by the ECU 20 at the predetermined intervals contains various data as detection results of sensors mounted on the vehicle and/or a control value for vehicle control. Hereinafter, a data frame that the ECU 20 transmits at a predetermined intervals will be referred to as a cycle frame, and a predetermined cycle at which the ECU 20 transmits the cycle frame will be referred to as a predetermined cycle T.

The “electronic control unit” may be a physically independent electronic control unit or a virtualized electronic control unit implemented using a virtualization technique.

Furthermore, when a specified event occurs, the ECU 20 transmits the data frame to the frame determination device 100 without depending on the predetermined cycle T. Hereinafter, a data frame that the ECU 20 transmits when an event occurs will be referred to as an event frame. When the ECU 20 transmits an event frame, the ECU 20 then transmits a cycle frame at a cycle T starting from the time when the event frame is transmitted.

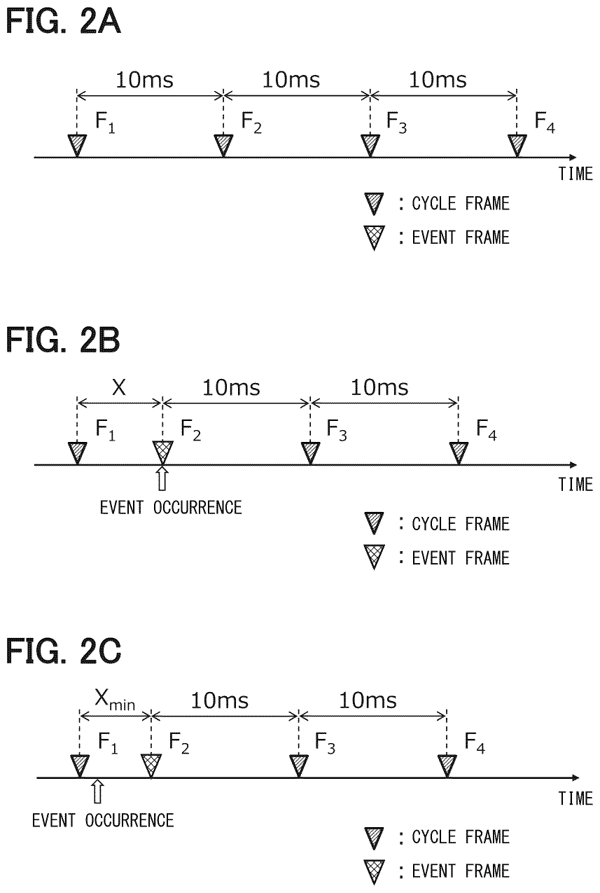

FIG. 2A to FIG. 2C are diagrams illustrating transmission of a data frame by the ECU 20. FIG. 2A shows a case where the ECU 20 transmits four cycle frames (F₁ to F₄) at a cycle T. By contrast, FIG. 2B shows a case where the frame F₂ transmitted next to the cycle frame F₁ is an event frame. The frame F₂ is transmitted when an event occurs. Therefore, the transmission interval x between the frame F₁ and the frame F₂ is shorter than the cycle T of 10 ms (millisecond). Further, the frame F₃ is transmitted at an interval of 10 ms starting from the time of transmitting the frame F₂. In FIG. 2A to FIG. 2C and the embodiments described later, the case where the cycle T is 10 ms is explained as an example, but the value of the cycle T is arbitrary.

The ECU 20 may set in advance the minimum value of the transmission interval for transmitting frames, that is, the minimum transmission interval (X min). FIG. 2C illustrates a case where an event occurs immediately after the ECU 20 transmits the frame F₁. When the minimum transmission interval X min is set, the ECU 20 does not transmit the event frame F₂ immediately after the event occurs, but transmits the frame F₂ after the minimum transmission interval X min has elapsed.

### (3) Configuration of the Frame Determination Device 100

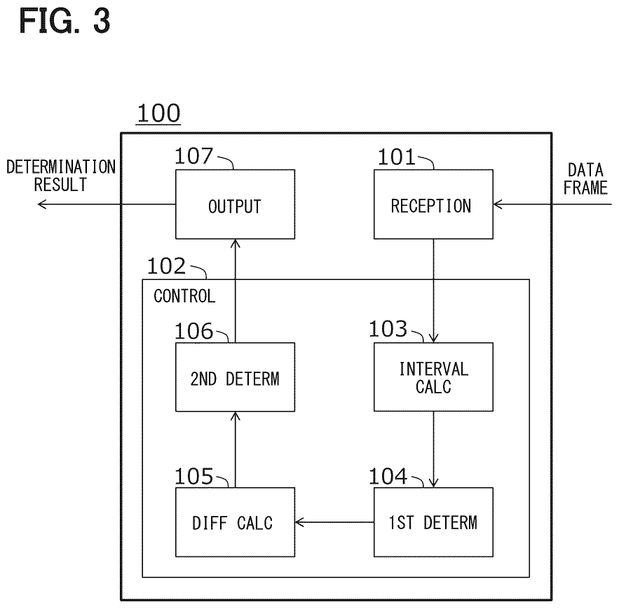

The configuration of the frame determination device 100 common to each embodiment will be described with reference to FIG. 3. The frame determination device 100 includes a reception unit 101, a control unit 102, and an output unit 107. The control unit 102 controls the operation of the reception unit 101 and the output unit 107. The control unit 102 further implements a reception interval calculation unit 103, a first determination unit 104, a difference calculation unit 105, and a second determination unit 106.

The reception unit 101 receives a data frame (corresponding to a “first data frame”) via CAN. The data frame received by the reception unit 101 is, in principle, a data frame transmitted from the ECU 20, that is, a cycle frame or an event frame. However, when an external attacker inserts a faked data frame as if the ECU 20 is a transmission source by unauthorized access, the reception unit 101 erroneously recognizes the received faked data frame as a data frame transmitted from the ECU 20. Therefore, the reception unit 101 receives not only data frames actually transmitted from the ECU 20 but also data frames that are mistakenly recognized as having been transmitted from the ECU 20.

The reception interval calculation unit 103 of the control unit 102 calculates a reception interval P between a data frame received by the reception unit 101 and a data frame (corresponding to “a second data frame”) that is a cycle frame or an event frame received by the reception unit 101 immediately before the data frame.

As described above, the ECU 20 transmits data frames at the cycle T. Therefore, when the reception unit 101 of the frame determination device 100 receives only cycle frames, the reception interval between the cycle frames is, in principle, equal to the cycle T. However, when the reception unit 101 receives an event frame or an abnormal frame inserted by unauthorized access, the reception interval between two data frames becomes shorter than the cycle T. Furthermore, the reception interval between two data frames may be shorter or longer than the cycle T depending on to the occurrence of delays in the data frames due to congestion in the communication network 2 or the time resolution of the time stamps that add time information to the data frames.

The first determination unit 104 determines whether the data frame received by the reception unit 101 is a cycle frame, based on the reception interval P calculated by the reception interval calculation unit 103. A data frame to be determined by the first determination unit 104 and a second determination unit 106 will be referred to as a target frame.

For example, the first determination unit 104 compares the reception interval P with a predetermined interval threshold PT. The first determination unit 104 determines whether the target frame is a cycle frame depending on whether the reception interval P is smaller than the interval threshold PT. Here, it may be desirable that the interval threshold PT is set to a value smaller than the cycle T. This is because, as described above, even when the ECU 20 transmits cycle frames at the cycle T, the actual reception interval P may be shorter than the cycle T due to the congestion of the communication network or the like. For example, a value of 90% or 80% of the cycle T, or a smaller value may be set as the interval threshold PT.

When the first determination unit 104 determines that the target frame is not a cycle frame, the difference calculation unit 105 calculates the “difference” between the reception time of the data frame actually received by the reception unit 101 after the target frame and the predicted reception time of a virtual data frame. The data frame actually received by the reception unit 101 after the target frame corresponds to an “actual received frame. The virtual data frame corresponds to a “virtual received frame”. The difference calculated by the difference calculation unit 105 will be described later in each embodiment.

Here, the “difference” is sufficient if it includes subtraction, and is not only a simple difference (y−x), but also a square difference (y²−x²), a square root of the difference ((y−x)^{1/2}), weighting difference (by-ax: a and b are constants).

The second determination unit 106 determines whether the target frame is an event frame or an abnormal frame based on the difference calculated by the difference calculation unit 105. Details of the second determination unit 106 will also be described later in each embodiment.

The output unit 107 outputs a determination result of the target frame. The output unit 107 transmits the determination result to, for example, a security operation center (SOC) or a server device located outside the vehicle. The output unit 107 may output the determination result indicating that the target frame is an abnormal frame only when the second determination unit 106 determines that the target frame is an abnormal frame. The output unit 107 may further transmit information regarding the abnormal frame (for example, reception time, identification number, data included in the abnormal frame) to the SOC or the server device.

### 2. First Embodiment

### (1) Configuration of the Frame Determination Device 100

The configuration of the frame determination device 100 specific to the present embodiment will be described. Specifically, the configurations of the difference calculation unit 105 and the second determination unit 106 will be described.

The difference calculation unit 105 of the present embodiment calculates two differences described below. The one difference is a difference (N) between the reception time of the N-th actual received frame, which is the data frame actually received by the reception unit 101 after the target frame, and the predicted reception time of the N-th virtual received frame, which is the cycle frame that the reception unit 101 expects to receive after the target frame when the target frame is assumed to be an event frame. Here, “N” indicates an integer of 1 or more. Hereinafter, such a difference will be referred to as a first difference.

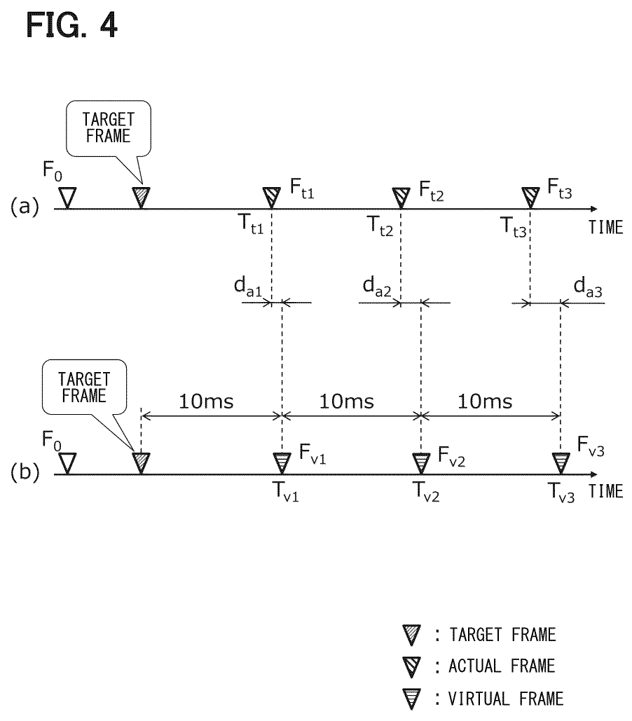

The first difference will be explained with reference to FIG. 4. A part (a) of FIG. 4 shows three (that is, N=1 to 3) actual received frames Fₜ₁ to Fₜ₃, which are data frames actually received by the reception unit 101 after the target frame. The reception times of these actual received frames are Tₜ₁, Tₜ₂, and Tₜ₃, respectively. By contrast, a part (b) FIG. 4 shows three virtual received frames Fᵥ₁ to Fᵥ₃ that are predicted to be received by the reception unit 101 after the target frame. The predicted reception times of these virtual received frames are Tᵥ₁, Tᵥ₂, and Tᵥ₃, respectively. Therefore, the difference calculation unit 105 calculates the difference dₐ₁ between the reception time of the first actual received frame and the predicted reception time of the first virtual received frame. Similarly, the difference calculation unit 105 calculates the differences dₐ₂ and dₐ₃. Although FIG. 4 and the embodiments to be described later are explained by exemplifying the case where N=1 to 3, the number of N is arbitrary.

The difference calculation unit 105 further calculates a second difference that is different from the first difference. The second difference is the reception time of the N-th actual received frame described above and the prediction that the reception unit 101 will receive the data frame after the data frame received immediately before the target frame, assuming that the target frame has not been received. This is the difference between the predicted reception time of the N-th virtual received frame, which is a cycle frame to be received. The second difference is a difference between the reception time of the N-th actual received frame and the predicted reception time of the N-th virtual received frame, which is the cycle frame that the reception unit 101 predicts to receive after the data frame received immediately before the target frame, assuming that the target frame is not received.

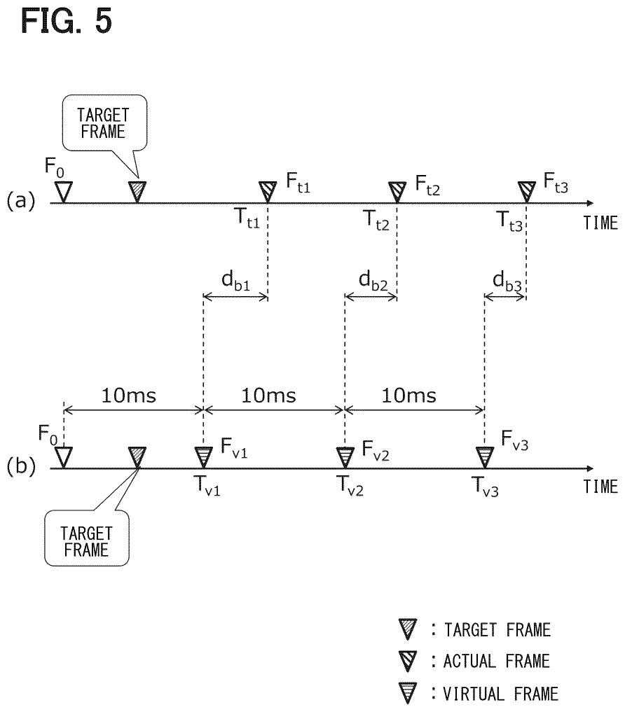

The second difference will be explained with reference to FIG. 5. A part (a) of FIG. 5 shows the same three actual received frames Fₜ₁ to Fₜ₃ as in the part (a) of FIG. 4. As in the part (a) of FIG. 4, the reception times of the actual received frames Fₜ₁ to Fₜ₃ are Tₜ₁, Tₜ₂, and Tₜ₃, respectively. On the other hand, a part (b) of FIG. 5 differs from the part (b) FIG. 4 in that, starting from the frame F₀ received immediately before the target frame, three virtual received frames Fᵥ₁ to Fᵥ₃ that are predicted to be received after the target frame are displayed. The predicted reception times of these virtual received frames are Tᵥ₁, Tᵥ₂, and Tᵥ₃, respectively. Therefore, the difference calculation unit 105 calculates the difference d_{b1} between the reception time of the first actual received frame Fₜ₁ and the predicted reception time of the first virtual received frame Fᵥ₁. Similarly, the difference calculation unit 105 calculates the differences d_{b2} and d_{b3}.

The difference calculation unit 105 calculates the “total value” Da (=dₐ₁+dₐ₂+dₐ₃) of the three first differences and the “total value” D_{b} (=d_{b1}+d_{b2}+d_{b3}) of the three second differences, respectively.

The “total value” may be a value obtained by adding a plurality of values, or a value obtained from a single value.

The second determination unit 106 determines whether the target frame is an event frame or an abnormal frame based on the first difference total value Dₐ and the second difference total value D_{b}. Specifically, the second determination unit 106 compares the total value Dₐ of the first differences with the total value D_{b} of the second differences. The second determination unit 106 determines that the target frame is an event frame when the total value Dₐ of the first differences is smaller than the total value D_{b} of the second differences. Here, the total value D_{b} of the second differences corresponds to a predetermined total threshold. The second determination unit 106 determines that the target frame is an abnormal frame when the total value Dₐ of the first differences is greater than the total value D_{b} of the second differences.

Here, the term of “than” includes both cases that include and exclude the same value as the compared object.

For example, in the examples of FIG. 4 and FIG. 5, the total value Dₐ of the first differences shown in FIG. 4 is clearly smaller than the total value D_{b} of the second differences shown in FIG. 5. Therefore, the second determination unit 106 determines that the target frames shown in the examples of FIG. 4 and FIG. 5 are event frames.

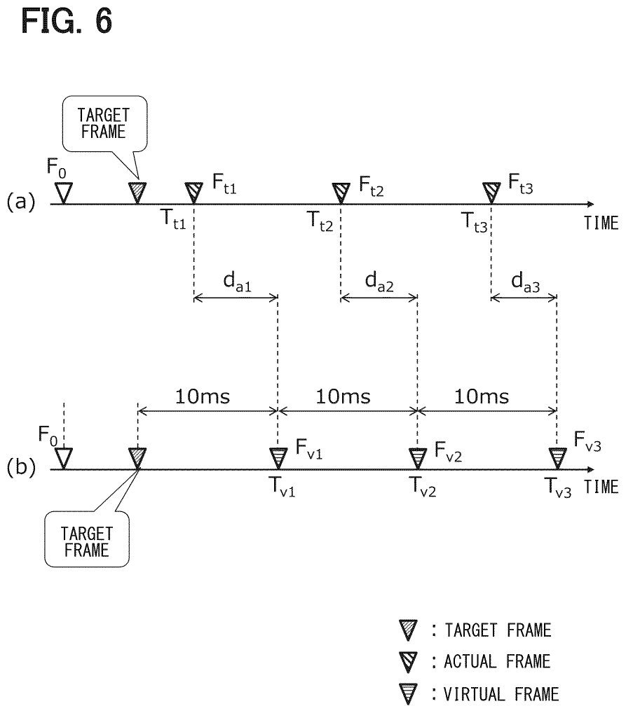

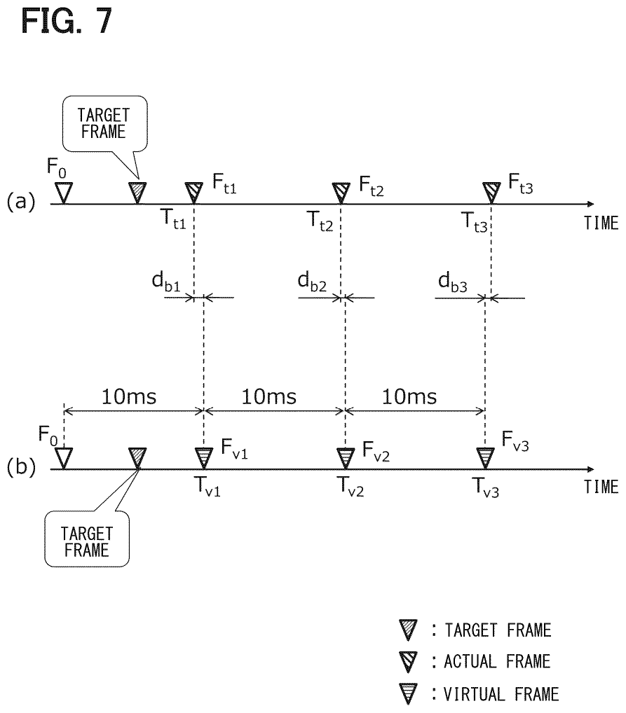

Here, for comparison, FIG. 6 and FIG. 7 illustrate a case where the target frame is an abnormal frame. When the target frame is an abnormal frame, the frame that the reception unit 101 receives after the frame F₀ should be a cycle frame that the ECU 20 transmits at a predetermined cycle T after the frame F₀. Therefore, the reception unit 101 receives the actual received frame Fₜ₁, which is a cycle frame, after approximately a cycle T has elapsed since receiving the frame F₀. Similarly, the reception unit 101 receives the actual received frame Fₜ₂ and the actual received frame Fₜ₃.

FIG. 6 is a diagram illustrating a first difference when the target frame is an abnormal frame. FIG. 7 is a diagram illustrating a second difference when the target frame is an abnormal frame. Unlike the examples in FIG. 4 and FIG. 5, in the examples in FIG. 6 and FIG. 7, the total value Dₐ of the three first differences shown in FIG. 6 is clearly greater than the total value D_{b} of the second differences shown in FIG. 7. Therefore, the second determination unit 106 determines that the target frames shown in the examples of FIG. 6 and FIG. 7 are abnormal frames.

In the examples shown in FIG. 4 to FIG. 7, the predicted reception time of the virtual received frame is calculated using the cycle T of 10 ms. The difference calculation unit 105 may calculate the predicted reception time using other values. For example, the predicted reception time may be calculated using an average value of the reception intervals previously calculated by the reception interval calculation unit 103. As described above, depending on the state of the communication network between the frame determination device 100 and the ECU 20, there may be a possibility that a frame may be delayed. Therefore, by using the average value of past reception intervals, it is possible to increase the possibility that a more accurate predicted reception time is derived. As another example, the difference calculation unit 105 may calculate the predicted reception time using the interval threshold PT used by the first determination unit 104 to determine whether the target frame is a cycle frame.

In the examples of FIG. 4 to FIG. 7, the total value of the first difference and the total value of the second difference are calculated using three actual received frames and three virtual received frames. The number of actual received frames and virtual received frames used to calculate the first difference and the second difference is arbitrary. For example, the total value of the first difference and the total value of the second difference may be calculated using one actual received frame and one virtual received frame. In this case, N=1, and the difference dₐ₁ between the first actual received frame and the first virtual received frame is the total value Dₐ of the first difference, and the difference d_{b1} between the first actual received frame and the first virtual received frame is the total value D_{b} of the second difference. However, by using a plurality of actual received frames and virtual received frames, it is possible to prevent a target frame from being erroneously determined to be an event frame or an abnormal frame due to, for example, an accidental frame delay or early arrival. Therefore, it is desirable that N be an integer of 2 or more.

The difference calculation unit 105 may weight the first and second differences, and calculate the total value of the weighted first difference and the total value of the weighted second difference, respectively. The difference calculation unit 105 may weight all the differences (n) using a constant weighting coefficient. It may be preferable to weight the differences (n) with a weighting coefficient greater than the difference (n+α) (1≤n<n+α≤N). As described above, even when the reception unit 101 receives cycle frames, the reception interval between the cycle frames is not necessarily the same as the cycle T. For example, in the example of FIG. 4, it is assumed that the reception interval of each of the target frame and actual received frames Fₜ₁, Fₜ₂, and Fₜ₃ is always a cycle T of 10 ms-0.2 ms. In this case, the differences dₐ₁, dₐ₂, and dₐ₃ are 0.2 ms, 0.4 ms, and 0.6 ms, respectively. In this way, the farther a frame is received from the target frame, the greater the difference between the reception time of the actual received frame and the predicted reception time of the virtual received frame. Therefore, weighting is performed so that the difference between an actual received frame received earlier and a virtual received frame has a greater weighing coefficient, and the difference between an actual received frame farther from the target frame and a virtual received frame has a smaller weighting coefficient.

The difference calculation unit 105 may change the weighting coefficient in steps. For example, the differences dₐ₁ and dₐ₂ may be weighted with the same weighting coefficient a, and the differences dₐ₃ and dₐ₄ may be weighted with a weighting coefficient b that is smaller than the weighting coefficient a.

In another example, the difference may be weighted depending on the content of data stored in the actual received frame. For example, when it is determined that reliability of the data stored in the actual received frame is high, it may be weighted with a large weighting coefficient. The reliability of data may be determined, for example, by whether a counter value included in data frames changes as expected. The reliability of data may be determined depending on whether data other than the counter value is expected data.

### (2) Operation of the Frame Determination Device 100

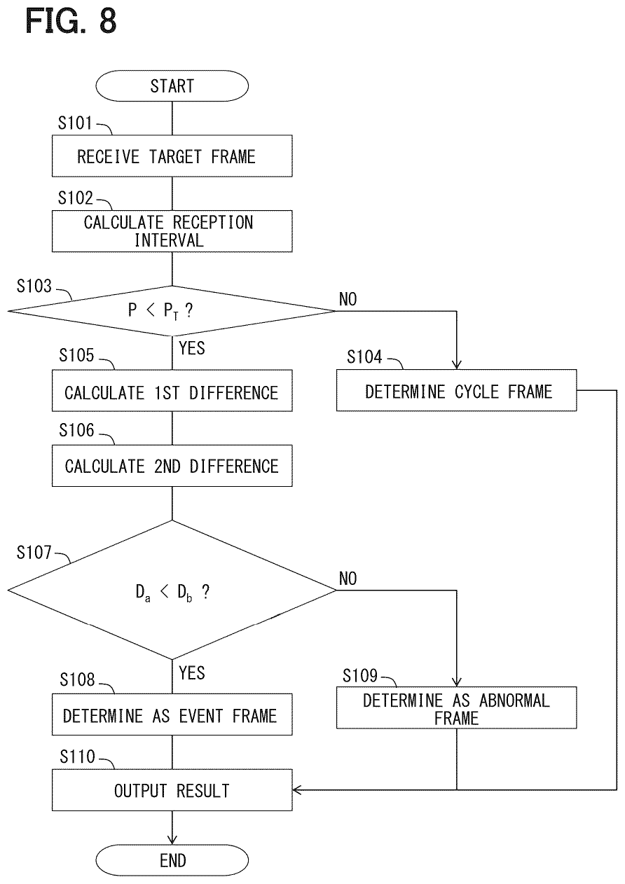

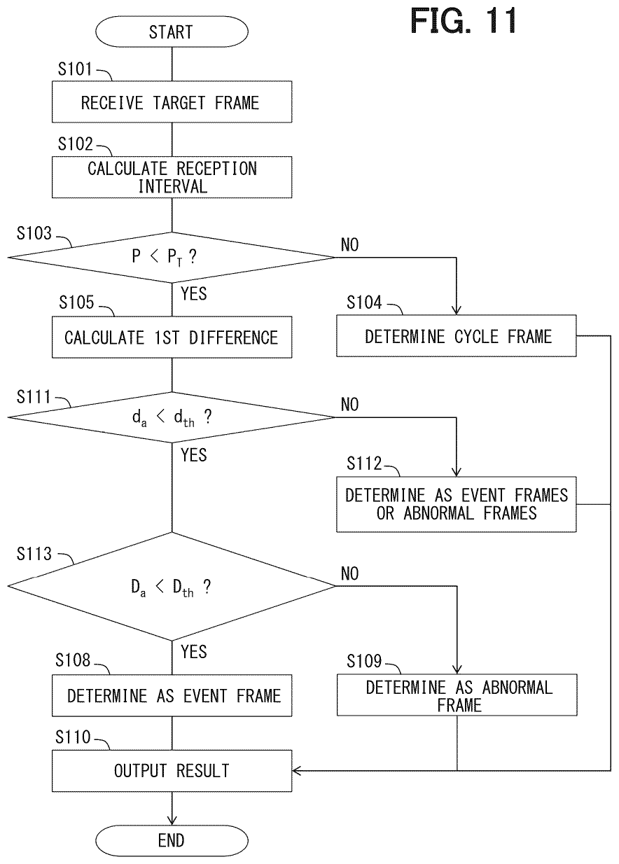

The operation of the frame determination device 100 will be described with reference to FIG. 8. FIG. 8 shows a method of determining frames in the frame determination device 100, and also shows a processing procedure of a program executed by the frame determination device 100. The processing is not limited to an order shown in FIG. 8. The order may be properly changed as long as there is no restriction such as a relationship in which a result of a preceding step is used in a subsequent step. The same applies to the flowcharts of the following embodiments. The processing procedure shown in FIG. 8 is repeatedly executed every time the frame determination device 100 receives a data frame. The same applies to FIG. 11 of the second embodiment.

The reception unit 101 receives a data frame, which is a target frame (S101). The reception interval calculation unit 103 calculates the reception interval P between the target frame and a data frame that the reception unit 101 received immediately before the target frame (S102). The first determination unit 104 compares the reception interval P and the interval threshold PT (S103). When the reception interval P is grater than the interval threshold PT (S103: N), the first determination unit 104 determines that the target frame is a cycle frame (S104).

As a result of the first determination unit 104 comparing the reception interval P and the interval threshold P_{T}, when the reception interval P is smaller than the interval threshold P_{T} (S103: Y), the difference calculation unit 105 calculates the first difference dₐ₁ to d_{aN} (S105). The difference calculation unit 105 calculates the second differences d_{b1} to d_{bN} (S106). The second determination unit 106 compares the total value Dₐ of the N first differences (that is, the N pieces of the first differences) with the total value D_{b} of the N second differences (that is, the N pieces of the second differences) (S107). Here, “N” represents an arbitrary integer. When the first difference total value Dₐ is smaller than the second difference total value D_{b} (S107: Y), the second determination unit 106 determines that the target frame is an event frame (S108). On the other hand, when the total value Dₐ of the first differences is grater than the total value D_{b} of the second differences (S107: N), the second determination unit 106 determines that the target frame is an abnormal frame (S109). The output unit 107 outputs the determination result of the target frame (S110).

### (3) Overview

As described above, according to the present embodiment, when a frame that is not a cycle frame is received, it is possible to determine with high accuracy whether the frame is an event frame or an abnormal frame.

### 3. Second Embodiment

In the method of the first embodiment, the first difference and the second difference are used to determine whether the target frame is an event frame or an abnormal frame. When a plurality of event frames or abnormal frames are received in a short period of time, there may be a shift in the predicted reception times, making it difficult to accurately determine the target frame. In the present embodiment, a configuration for determining that a plurality of event frames or abnormal frames have been received will be described.

### (1) Configuration of the Frame Determination Device 100

The difference calculation unit 105 of the present embodiment calculates the first difference. The method of calculating the first difference in the difference calculation unit 105 is the same as in the first embodiment. Further, as in the first embodiment, the difference calculation unit 105 may weight the calculated first difference. In the present embodiment, the difference calculation unit 105 does not calculate the second difference.

The second determination unit 106 of the present embodiment compares each of the N first differences da calculated by the difference calculation unit 105 with a predetermined difference threshold dₜₕ. The predetermined difference threshold dₜₕ is set based on a predetermined cycle T, for example. As an example, when an error of ±20% is assumed for the predetermined cycle T, the predetermined difference threshold dₜₕ may be set to a value of 20% of the predetermined cycle T (i.e., T×0.2).

As a result of comparing the first difference da and the predetermined difference threshold dₜₕ, when all of the first differences are smaller than the predetermined difference threshold dₜₕ, the second determination unit 106 compares the total value Dₐ of the N first differences with the predetermined total threshold value Dₜₕ. Then, when the total value Dₐ of the first differences is smaller than a predetermined total threshold Dₜₕ, it is determined that the target frame is an event frame. On the other hand, when the total value Dₐ of the first differences is greater than the predetermined total threshold value Dₜₕ, it is determined that the target frame is an abnormal frame.

On the other hand, as a result of comparing the first difference da and the predetermined difference threshold dₜₕ, when at least one of the first differences is greater than the predetermined difference threshold dₜₕ, the second determination unit 106 determines that the reception unit 101 determines that a plurality of event frames or a plurality of abnormal frames have been received. When the plurality of event frames or the plurality of abnormal frames are received, it is difficult to determine whether the target frame is an event frame or an abnormal frame. When the second determination unit 106 determines that a plurality of event frames or a plurality of abnormal frames have been received, the output unit 107 of the present embodiment may output a determination result indicating that it is unable to determine whether the target frame is an event frame or an abnormal frame.

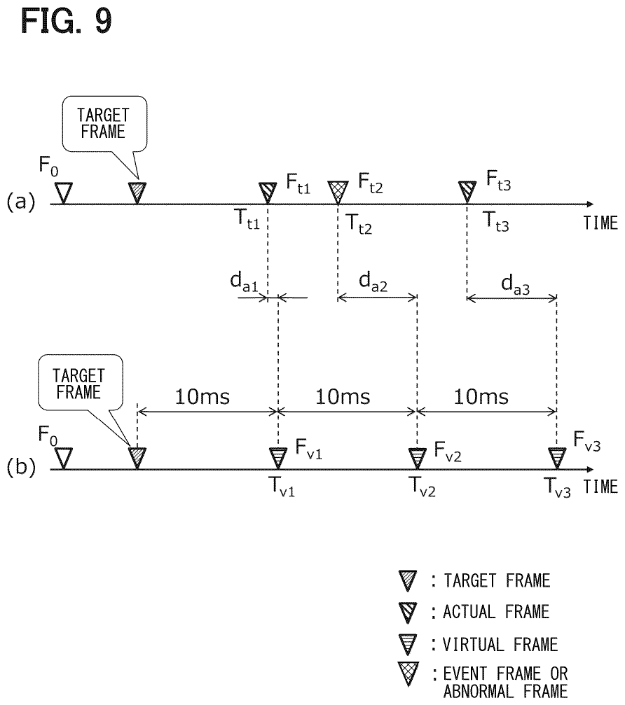

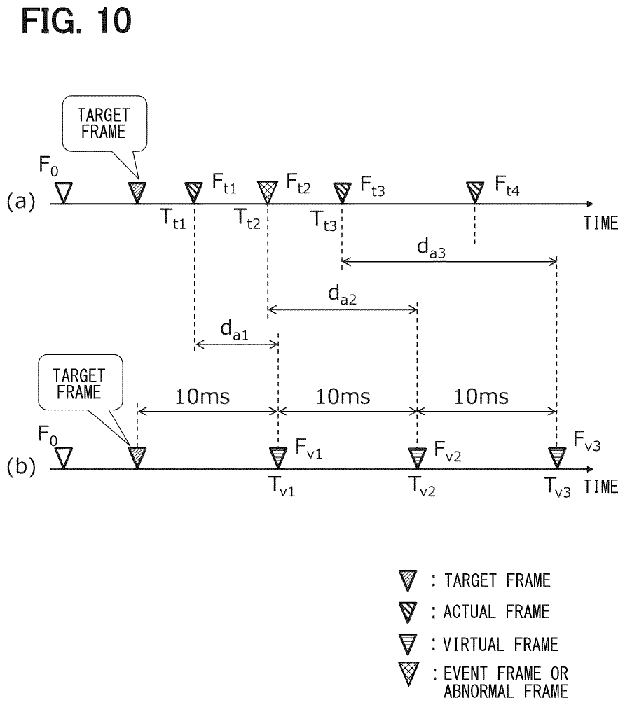

FIG. 9 and FIG. 10 are diagrams illustrating a case where an event frame or an abnormal frame is received as frame Fₜ₂ after the target frame. FIG. 9 shows a case where the target frame and the frame Fₜ₂ are event frames. FIG. 10 shows a case where the target frame and the frame Fₜ₂ are abnormal frames.

In FIG. 9, since the frame Fₜ₂, which is an event frame, is received, the difference dₐ₃ between the reception time Tₜ₃ of the actual received frame Fₜ₃ and the predicted reception time Tᵥ₃ of the virtual received frame Fᵥ₃ is relatively large, and is greater than the predetermined difference threshold dₜₕ. The second determination unit 106 can determine that an event frame or an abnormal frame has been received in addition to the target frame. The second determination unit 106 determines that a plurality of event frames or abnormal frames have been received.

In FIG. 10, since the frame Fₜ₂, which is an abnormal frame, is received, the difference dₐ₂ between the reception time Tₜ₂ of the actual received frame Fₜ₂ and the predicted reception time Tᵥ₂ of the virtual received frame Fᵥ₂, and the difference dₐ₃ between the reception time Tts of the actual received frame Fₜ₃ and the predicted reception time Tᵥ₃ of the virtual received frame Fᵥ₃ are relatively large, and are greater than the predetermined difference threshold dₜₕ. Therefore, as in the case of FIG. 9, the second determination unit 106 can determine that a plurality of event frames or abnormal frames have been received.

In this way, in the present embodiment, it is possible to determine whether the target frame is an event frame or an abnormal frame without calculating the second difference. Compared to the first embodiment, it is possible to determine the target frame while suppressing the amount of calculation in the control unit 102.

### (2) Operation of the Frame Determination Device 100

The operation of the frame determination device 100 of the present embodiment will be described with reference to FIG. 11. The same processes as in the frame determination device 100 of the first embodiment are given the same reference numerals, and detailed explanations will be omitted.

In S105, after the difference calculation unit 105 calculates the N first differences dₐ₁ to d_{aN}, the second determination unit 106 compares the first differences dₐ₁ to d_{aN} calculated in S105 with the difference threshold dₜₕ (S111). When at least one of the first differences is greater than the difference threshold dₜₕ (S111: N), the second determination unit 106 determines that the reception unit 101 has received a plurality of event frames or abnormal frames (S112). Further, when each of the first differences is smaller than the difference threshold dₜₕ, the second determination unit 106 further compares the total value Dₐ of the first differences with the total threshold Dₜₕ (S113). When the total value Dₐ of the first differences is smaller than the total threshold value Dₜₕ (S113: Y), the second determination unit 106 determines that the target frame is an event frame (S108). When the total value Dₐ of the first differences is greater than the total threshold value Dₜₕ (S113: N), it is determined that the target frame is an abnormal frame (S109).

### (3) Overview

As described above, according to the present embodiment, it is possible to determine whether a target frame is an event frame or an abnormal frame while suppressing the amount of calculation required to determine the target frame compared to the first embodiment. Furthermore, in the present embodiment, it is possible to determine that a plurality of event frames or abnormal frames have been received.

### 4. Third Embodiment

### OTHER EMBODIMENTS

When the minimum transmission interval X min at which the ECU 20 transmits frames is set, the frame determination device 100 may determine whether the target frame is an event frame or an abnormal frame using the minimum transmission interval X min.

As shown in FIG. 20, when the minimum transmission interval X min is set, the ECU 20 transmits an event frame after the minimum transmission interval X min has elapsed. Therefore, when the reception interval P calculated by the reception interval calculation unit 103 is smaller than the minimum transmission interval X min, there is a high possibility that the target frame is not an event frame but an abnormal frame. Therefore, the first determination unit 104 determines that the target frame is an abnormal frame when the reception interval P is smaller than the minimum transmission interval X min.

The embodiment may be combined with the first and second embodiments. In this case, the first determination unit 104 first compares the reception interval P and the minimum transmission interval X min, and when the reception interval P is greater than the minimum transmission interval X min, then the first determination unit 104 compares the reception interval P and the interval threshold P_{T} to determine whether the target frame is a cycle frame.

### 5. Overview

The features of the frame determination device and the like of the present disclosure have been described above.

Since terms used in the embodiments are examples, the terms may be replaced with synonymous terms or terms including synonymous functions.

The block diagrams used for the description of the embodiments are obtained by classifying and organizing the configurations of the devices for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding processes are used in one other process.

The terms such as first, second, to N-th (where N is an integer) used in each embodiment and in the claims are used to distinguish two or more configurations and methods of the same kind and are not intended to limit the order or superiority.

In the above-described embodiments, the frame determination device is mounted on the vehicle. However, the present disclosure may be used for the frame determination device for special devices or general purpose devices other than vehicles.

Moreover, the following can be mentioned as an example of the form of the frame determination device of the present invention. Examples of a form of a component include a semiconductor element, an electronic circuit, a module, and a microcomputer. Examples of a form of a semi-finished product include an electric control unit (ECU) and a system board. Examples of a form of a finished product include a cellular phone, a smartphone, a tablet computer, a personal computer (PC), a workstation, and a server. In addition, the devices may include a device having a communication function or the like, and examples thereof include a video camera, a still camera, and a car navigation system.

Further, necessary functions such as an antenna and a communication interface may be added to the frame determination device.

The device can be implemented not only by dedicated hardware having the configurations and functions described in the embodiments, but also by a combination of a program, which is recorded on a recording medium such as a memory or a hard disk and is used for implementing the invention, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the recording medium or from a server via a communication line without using the recording medium. Thereby, the latest functions can be provided at all times through program upgrade.

What is claimed is:

1. A frame determination device connected to a network that transmits a cycle frame and an event frame transmitted from an electronic control device, the cycle frame being a data frame that is transmitted at a predetermined cycle starting from transmission of the cycle frame or the event frame that have been transmitted immediately before from the electronic control device, the event frame being a data frame that is transmitted when a predetermined event occurs regardless of the predetermined cycle, the frame determination device comprising:
a reception unit that is configured to receive a first data frame;
a reception interval calculation unit that is configured to calculate a reception interval between the first data frame and a second data frame, which is the cycle frame or the event frame received by the reception unit immediately before the first data frame;
a first determination unit that determines whether the first data frame is the cycle frame based on the reception interval;
a difference calculation unit that is configured to calculate a difference (N) between a reception time of an N-th (N being an integer greater than or equal to 1) actual received frame, which is a data frame actually received by the reception unit after the first data frame, and a predicted reception time of an N-th virtual received frame, which is a cycle frame that the reception unit predicts to receive after the first data frame when the first data frame is assumed to be an event frame, when the first determination unit determines that the first data frame is not the cycle frame;
a second determination unit that is configured to determine, based on the difference, whether the first data frame is an event frame or an abnormal frame different from the event frame; and
an output unit that is configured to output a determination result of the first data frame.

2. The frame determination device according to claim 1, wherein
the N is an integer of 2 or more.

3. The frame determination device according to claim 1, wherein
the second determination unit determines that the first data frame is the event frame in a case where a total value of N pieces of differences is smaller than a predetermined total threshold; and
the second determination unit determines that the first data frame is the abnormal frame in a case where the total value of the N pieces of the differences is greater than the predetermined total threshold.

4. The frame determination device according to claim 3, wherein
in addition to a first difference, which is the difference, the difference calculation unit calculates a second difference, which is a difference between a reception time of an N-th actual received frame and a predicted reception time of an N-th virtual received frame, which is a plurality of cycle frames that the reception unit predicts to receive after the second data frame in assuming the first data frame is not received, and
the predetermined total threshold is a total value of N pieces of second differences.

5. The frame determination device according to claim 3, wherein:
the second determination unit compares the total value of the differences with a predetermined total threshold value when all of the N pieces of the differences are smaller than a predetermined difference threshold.

6. The frame determination device according to claim 5, wherein
the second determination unit determines that a plurality of event frames or a plurality of abnormal frames have been received when at least one of the N pieces of the differences is greater than the predetermined difference threshold.

7. The frame determination device according to claim 6, wherein
when the second determination unit determines that the plurality of event frames or the plurality of abnormal frames have been received, the output unit outputs the determination result indicating that it is unable to determine whether the first data frame is the event frame or the abnormal frame.

8. The frame determination device according to claim 1, wherein
the difference calculation unit calculates a predicted reception time using the predetermined cycle.

9. The frame determination device according to claim 1, wherein
the difference calculation unit calculates a predicted reception time using the reception interval calculated in past by the reception interval calculation unit.

10. The frame determination device according to claim 2, wherein
the difference calculation unit weights the difference (n) with a weighting coefficient greater than the difference (n+α) (1≤n<n+α≤N).

11. The frame determination device according to claim 2, wherein
the difference calculation unit weights the difference (n) according to data stored in the actual received frame.

12. A frame determination method executed by a frame determination device connected to a network that transmits a cycle frame and an event frame transmitted from an electronic control device, the cycle frame being a data frame that is transmitted at a predetermined cycle starting from transmission of the cycle frame or the event frame that have been transmitted immediately before from the electronic control device, the event frame being a data frame that is transmitted when a predetermined event occurs regardless of the predetermined cycle, the frame determination method comprising:
receiving a first data frame;
calculating a reception interval between the first data frame and a second data frame, which is the cycle frame or the event frame received immediately before the first data frame;
determining whether the first data frame is the cycle frame based on the reception interval;
calculating a difference (N) between a reception time of an N-th (N being an integer greater than or equal to 1) actual received frame, which is a data frame actually received after the first data frame, and a predicted reception time of an N-th virtual received frame, which is a cycle frame that a reception unit predicts to receive after the first data frame when the first data frame is assumed to be an event frame, when it is determined that the first data frame is not the cycle frame;
determining, based on the difference, whether the first data frame is an event frame or an abnormal frame different from the event frame; and
outputting a determination result of the first data frame.

13. A non-transitory computer readable storage medium storing a frame determination program executed by a frame determination device connected to a network that transmits a cycle frame and an event frame transmitted from an electronic control device, the cycle frame being a data frame that is transmitted at a predetermined cycle starting from transmission of the cycle frame or the event frame that have been transmitted immediately before from the electronic control device, the event frame being a data frame that is transmitted when a predetermined event occurs regardless of the predetermined cycle, the frame determination program causing the frame determination device to:
receive a first data frame;
calculate a reception interval between the first data frame and a second data frame, which is the cycle frame or the event frame received immediately before the first data frame;
determine whether the first data frame is the cycle frame based on the reception interval;
calculate a difference (N) between a reception time of an N-th (N being an integer greater than or equal to 1) actual received frame, which is a data frame actually received after the first data frame, and a predicted reception time of an N-th virtual received frame, which is a cycle frame that a reception unit predicts to receive after the first data frame when the first data frame is assumed to be an event frame, when it is determined that the first data frame is not the cycle frame;
determine, based on the difference, whether the first data frame is an event frame or an abnormal frame different from the event frame; and
output a determination result of the first data frame.

14. A frame determination system comprising:
an electronic control device; and
a frame determination device connected to a network that transmits a cycle frame and an event frame transmitted from the electronic control device,
wherein:
the electronic control device transmits the cycle frame at a predetermined cycle starting from transmission of the cycle frame or the event frame that have been transmitted immediately before, and the event frame regardless of the predetermined cycle when a predetermined event occurs, and
the frame determination device includes:
a reception unit that is configured to receive a first data frame;
a reception interval calculation unit that is configured to calculate a reception interval between the first data frame and a second data frame, which is the cycle frame or the event frame received by the reception unit immediately before the first data frame;
a first determination unit that determines whether the first data frame is the cycle frame based on the reception interval;
a difference calculation unit that is configured to calculate a difference (N) between a reception time of an N-th (N being an integer greater than or equal to 1) actual received frame, which is a data frame actually received by the reception unit after the first data frame, and a predicted reception time of an N-th virtual received frame, which is a cycle frame that the reception unit predicts to receive after the first data frame when the first data frame is assumed to be an event frame, when the first determination unit determines that the first data frame is not the cycle frame;
a second determination unit that is configured to determine, based on the difference, whether the first data frame is an event frame or an abnormal frame different from the event frame; and
an output unit that is configured to output a determination result of the first data frame.

15. A frame determination method executed by a frame determination system including an electronic control device, and a frame determination device connected to a network that transmits a cycle frame and an event frame transmitted from the electronic control device, the cycle frame being a data frame that is transmitted at a predetermined cycle starting from transmission of the cycle frame or the event frame that have been transmitted immediately before from the electronic control device, the event frame being a data frame that is transmitted when a predetermined event occurs regardless of the predetermined cycle, the frame determination method comprising:
receiving a first data frame;
calculating a reception interval between the first data frame and a second data frame, which is the cycle frame or the event frame received immediately before the first data frame;
determining whether the first data frame is the cycle frame based on the reception interval;
calculating a difference (N) between a reception time of an N-th (N being an integer greater than or equal to 1) actual received frame, which is a data frame actually received after the first data frame, and a predicted reception time of an N-th virtual received frame, which is a cycle frame that a reception unit predicts to receive after the first data frame when the first data frame is assumed to be an event frame, when it is determined that the first data frame is not the cycle frame;
determining, based on the difference, whether the first data frame is an event frame or an abnormal frame different from the event frame; and
outputting a determination result of the first data frame.
